(19) United States
(12) Patent Application Publication
(10) Pub. No.: US 2004/0002346 A1
(43) Pub. Date: Jan. 1, 2004

(54) Ultra-wideband geographic location system and method

(76) Inventor: John Santhoff, San Diego, CA (US)

Correspondence Address: PETER R. MARTINEZ, ESQ., Suite 200, 11988 El Camino Real, San Diego, CA, 92130, US

(21) Appl. No.: 10/609,522

(22) Filed: Jun. 27, 2003

Related U.S. Application Data
(63) Continuation-in-part of application No. 10/236,213, filed on Sep. 6, 2002.
Application No. 10/236,213 is a continuation-in-part of application No. 09/745,498, filed on Dec. 22, 2000, now Pat. No. 6,519,464.
(60) Provisional application No. 60/255,469, filed on Dec. 14, 2000.

(51) Int. Cl. H04M 1/00

(52) U.S. Cl. 455/456.1; 455/456.2; 455/456.5

(57) ABSTRACT

A system, method and article of manufacture are provided for reporting a location of a wireless device. In one embodiment, an emergency signal is transmitted from the wireless device. The emergency signal is received by at least two access points. The two access points transmit at least two ultra-wideband signals in response, the ultra-wideband signals containing information about the geographic locations of the access points. The geographic location of the wireless device is determined using the geographic locations of the access points. The geographic location of the wireless device is then transmitted. This Abstract is provided for the sole purpose of complying with the Abstract requirement rules that allow a reader to quickly ascertain the subject matter of the disclosure contained herein. This Abstract is submitted with the explicit understanding that it will not be used to interpret or to limit the scope or the meaning of the claims.

This is a continuation-in-part of co-pending U.S. patent application Ser. No. 10/236,213, titled USE OF THIRD PARTY ULTRA-WIDEBAND DEVICES TO ESTABLISH GEO-POSITIONAL DATA, filed Aug. 28, 2002, which is a continuation-in-part of U.S. Pat. No. 6,519,464, issued Feb. 11, 2003, titled USE OF THIRD PARTY ULTRA-WIDEBAND DEVICES TO ESTABLISH GEO-POSITIONAL DATA, filed Dec. 22, 2000, which claims priority to U.S. provisional application serial no. 60/255,469, filed Dec. 14, 2000, titled ULTRA-WIDEBAND COMMUNICATION SYSTEM AND METHOD.

### FIELD OF THE INVENTION

The present invention relates generally to wireless communication systems and, more particularly, to accurate geographical location of ultra-wideband transceivers.

### BACKGROUND OF THE INVENTION

Ultra-wideband communication systems and devices benefit from the tremendous potential for geo-positional accuracy of ultra-wideband technology. As a separate issue, the FCC has recently required all existing cellular technology providers to employ some means of geographically locating all cellular phones for emergency purposes. This initiative has been termed “e911” and will be a requirement of future cellular technologies. Thus, it is foreseeable that the same demands will be placed on future ultra-wideband devices.

Conventionally, ultra-wideband geo-positional information may be obtained by triangulating signals from three separate ultra-wideband transmission towers whose fixed position is known. However, it is foreseeable that a mobile ultra-wideband device may not always be within range of three fixed transmission towers. In such a situation, the ultra-wideband device's geo-location (i.e., geo-position) may not be determined through the conventional methods.

Thus, it may be appreciated that a geo-location method that takes advantage of other mobile ultra-wideband devices of known location to derive the position of the ultra-wideband device that is in need of location has a better chance of success in these circumstances.

### SUMMARY OF THE INVENTION

A system, method and article of manufacture are provided for determining and reporting a location of a wireless device in a wireless communication system. In one embodiment of the present invention, an emergency signal is transmitted from the wireless device. The emergency signal is received by at least two access points. The two access points transmit at least two ultra-wideband signals in response, the ultra-wideband signals containing information about the geographic locations of the access points. The geographic location of the wireless device is determined using the geographic locations of the access points. The geographic location of the wireless device is then transmitted.

In another embodiment of the present invention, at least two access points periodically transmit a geographic location signal, which is used by a wireless communication device to determine its geographic location. The geographic location of the wireless device is then transmitted, along with a 911 emergency signal.

These and other features and advantages of the present invention will be appreciated from review of the following detailed description of the invention, along with the accompanying figures in which like reference numerals refer to like parts throughout.

### BRIEF DESCRIPTION OF THE DRAWINGS

The foregoing and other features, aspects and advantages are better understood from the following detailed description, appended claims, and accompanying drawings where:

FIG. 1 is a schematic diagram of an exemplary ultra-wideband communication system capable of utilizing a multiple access scheme in accordance with an embodiment of the present invention,;

FIG. 2 is a schematic diagram of an ultra-wideband geo-positional model;

FIG. 3 is a schematic block diagram of an ultra-wideband wireless device/transceiver in accordance with an embodiment of the present invention;

FIG. 4 is a schematic diagram of an ultra-wideband geo-positional model where multiple mobile devices collaborate with a requesting device to allow the requesting device to determine its location in accordance with an embodiment of the present invention;

FIG. 5 is a flowchart of a process for triangulation and storage of the geo-positional information based on three fixed position devices in accordance with an embodiment of the present invention;

FIG. 6 is a flowchart of a process for determining and storing a geographic location of a mobile wireless device in a wireless communication system in accordance with an embodiment of the present invention;

FIG. 7 is a flowchart processing replies from other wireless devices and 15 testing for data quantity and quality criteria in accordance with an embodiment of the present invention;

FIG. 8 is a flowchart of a process for performing a ranging dialogue to determine a requesting wireless device's distance from other replying wireless devices in accordance with an embodiment of the present invention;

FIG. 9 is a flowchart of a process for time correction in a requesting wireless device in accordance with an embodiment of the present invention;

FIG. 10 is a schematic diagram of a representative hardware environment in accordance with an embodiment of the present invention;

FIG. 11 is an illustration of different communications methods;

FIG. 12 is an illustration of two ultra-wideband pulses;

FIG. 13 is a schematic diagram of an ultra-wideband geo-positional model where multiple mobile devices collaborate with a requesting device to allow the requesting device to determine its location and elevation in accordance with an embodiment of the present invention;

FIG. 14 is a flowchart of a method for determining a geographical location of a mobile device in accordance with one embodiment of the present invention;

FIG. 15 is a flowchart of a method for determining a geographical location of a fixed device in accordance with one embodiment of the present invention;

FIG. 16 is an illustration of a mobile device located within communication range of two fixed access points;

FIG. 17 is an illustration of a mobile device located within communication range of three fixed access points;

FIG. 18 is an illustration of a mobile device located within communication range of two fixed access points and a mobile device;

FIG. 19 is a schematic block diagram of an ultra-wideband wireless device/transceiver in accordance with one embodiment of the present invention; and

FIG. 20 is a schematic block diagram of another ultra-wideband wireless device/transceiver in accordance with a second embodiment of the present invention.

It will be recognized that some or all of the Figures are schematic representations for purposes of illustration and do not necessarily depict the actual relative sizes or locations of the elements shown.

### DETAILED DESCRIPTION OF THE INVENTION

In the following paragraphs, the present invention will be described in detail by way of example with reference to the attached drawings. Throughout this description, the preferred embodiment and examples shown should be considered as exemplars, rather than as limitations on the present invention. As used herein, the “present invention” refers to any one of the embodiments of the invention described herein, and any equivalents. Furthermore, reference to various feature(s) of the “present invention” throughout this document does not mean that all claimed embodiments or methods must include the referenced feature(s).

Embodiments of the present invention use the known geographic position of one or more mobile wireless devices (in a preferred embodiment, ultra-wideband devices) to triangulate the position of additional mobile wireless devices that are not within geographic range of three mobile or fixed wireless devices such as fixed base stations and/or transmission towers, or mobile wireless devices. It should be understood that the mobile wireless devices whose positions are known need not be restricted just to handheld-type mobile devices. Such devices may also include ultra-wideband components in mobile phones, mobile internet devices, portable radios, personal data assistants, desktop computers or appliances located in homes, automobiles, office environments and other ultra-wideband devices.

A preferred embodiment of the present invention employs ultra-wideband, or impulse radio that comprises a multiplicity of electromagnetic pulses that are emitted at nanosecond or picosecond intervals (generally tens of picoseconds to a few nanoseconds in duration). For this reason, ultra-wideband is often called “impulse radio.” Because the excitation pulse is not a modulated waveform, UWB has also been termed “carrier-free” in that no apparent carrier frequency is evident in the radio frequency (RF) spectrum. That is, the UWB pulses are transmitted without modulation onto a sine wave carrier frequency, in contrast with conventional radio frequency technology. For example, ultra-wideband requires neither an assigned frequency nor a power amplifier.

Conventional radio frequency technology employs continuous sine waves that are transmitted with data embedded in the modulation of the sine waves' amplitude or frequency. For example, a conventional cellular phone must operate at a particular frequency band of a particular width in the total frequency spectrum. Specifically, in the United States, the Federal Communications Commission has allocated cellular phone communications in the 800 to 900 MHz band. Cellular phone operators use 25 MHz of the allocated band to transmit cellular phone signals, and another 25 MHz of the allocated band to receive cellular phone signals.

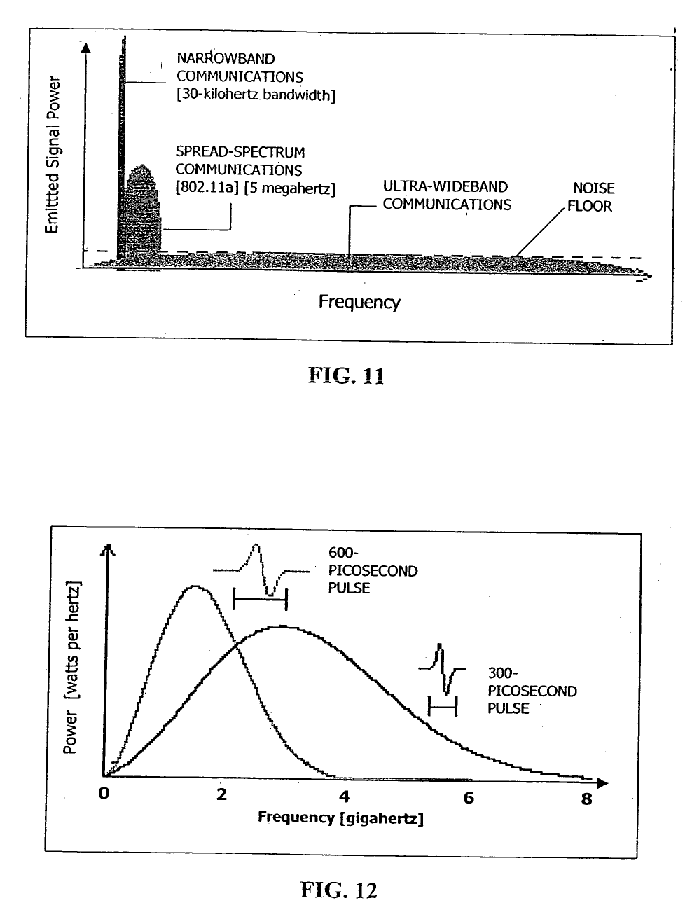

Another example of a conventional radio frequency technology is illustrated in FIG. 11. 802.11a, a wireless local area network (LAN) protocol, transmits radio frequency signals at a 5 GHz center frequency, with a radio frequency spread of about 5 MHz.

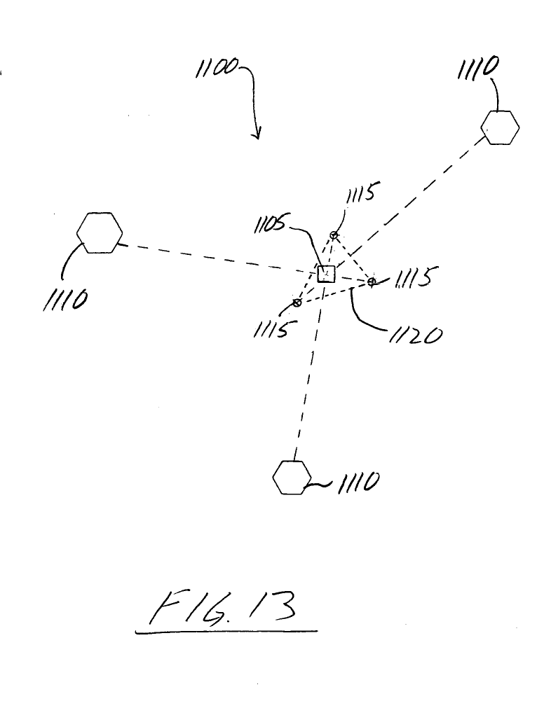

In contrast, an UWB pulse may have a 1.8 GHz center frequency, with a frequency spread of approximately 1.6 GHz, as shown in FIG. 12, which illustrates two typical UWB pulses. FIG. 12 illustrates that the narrower the UWB pulse is in time, the higher its center frequency and the broader the spread of its frequency spectrum. This is because frequency is inversely proportional to the time duration of the pulse. A 600 picosecond UWB pulse will have about a 1.8 GHz center frequency, with a frequency spread of approximately 1.6 GHz. And a 300 picosecond UWB pulse will have about a 3 GHz center frequency, with a frequency spread of approximately 3.2 GHz. Thus, UWB pulses generally do not operate within a specific frequency, as shown in FIG. 11. And because UWB pulses are spread across an extremely wide frequency range, UWB communication systems allow communications at very high data rates, such as 100 megabits per second or greater.

Also, because the UWB pulse is spread across an extremely wide frequency range, the power sampled at a specific frequency is very low. For example, a UWB one-watt signal of one nano-second duration spreads the one-watt over the entire frequency occupied by the pulse. At any instantaneous frequency, such as at the carrier frequency of a 802.11a system, the UWB pulse power present is about one nano-watt (for a frequency band of 1 GHz). This is well within the noise floor of the 802.11a system and therefore does not interfere with the transmission of the 802.11a signals. Generally, the multiplicity of UWB pulses are transmitted at relatively low power (when sampled at a specific frequency), for example, at less than −30 power decibels to −60 power decibels.

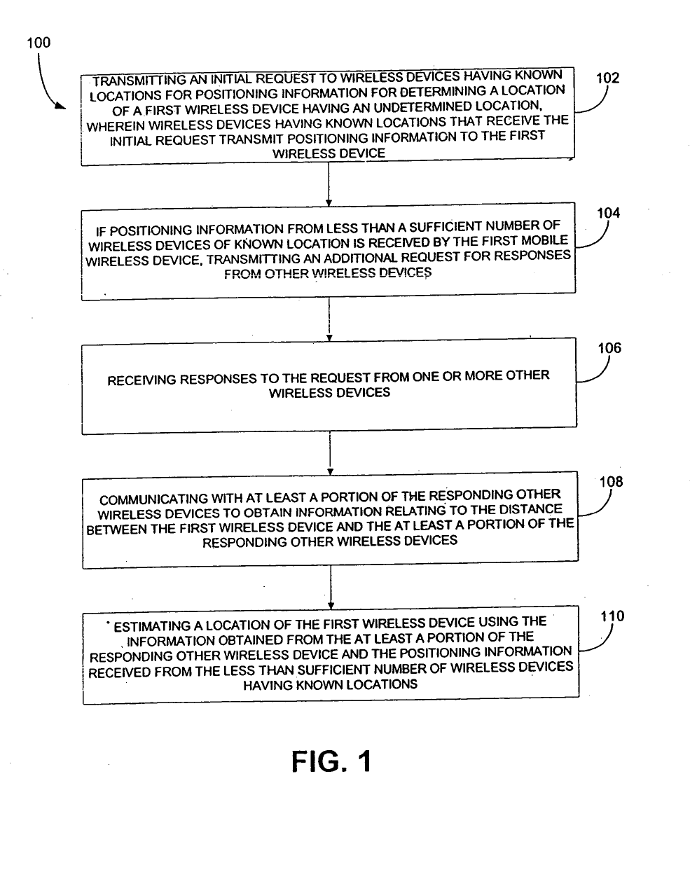

FIG. 1 is a flowchart of a process 100 for determining a geographic location of a mobile wireless device having an undetermined/unknown geographic location in a wireless communication system in accordance with an embodiment of the present invention. In operation 102, at least one initial request is transmitted from a first mobile wireless device having an undetermined/unknown geographic location to fixed position wireless devices having known geographic locations (e.g., such as base stations and/or transmission towers) for positioning information for determining a geographic location of the first mobile wireless device. Those fixed position wireless devices with known geographic locations that receive the initial request (i.e., in the communication range of the first mobile wireless device) transmit, in response, positioning information to the first mobile wireless device with the undetermined geographic location (Note: for purposes of this portions of the description, communication range may be defined as a region inside which wireless communication with the first mobile wireless device may be achieved).

If positioning information from less than a sufficient number of fixed position wireless devices of known geographic location is received by the first mobile wireless device (e.g., such as when less than the sufficient number of fixed position wireless devices are in the communication range of the first mobile wireless device), then in operation 104, the first mobile wireless device then transmits an additional request for responses/replies from other mobile wireless devices in the communication range of the first mobile wireless device. In one aspect of the present invention, at least a portion of the transmitted requests may be coded (such as in the form of a key sequence request). Responses to the request are then received by the first wireless device from one or more other mobile wireless devices in the communication range in operation 106. Communication is then initiated in operation 108 with at least a portion of the responding other mobile wireless devices to obtain information (i.e., data) relating to the distance between the first mobile wireless device and the responding other mobile wireless devices communicating with the first mobile wireless device.

In operation 110, a position/location of the first mobile wireless device is 20 then estimated with a triangulation method using the information obtained from the responding other mobile wireless device communicating with the first wireless device and (if any was received by the first mobile wireless device) positioning information received from the less than sufficient number of fixed position wireless devices with known geographic locations.

In an aspect of the present invention, the sufficient number of fixed position wireless devices with known geographic locations. In another aspect of the present invention, the devices with known geopraphic locations. In another aspect of the present invention, the additional request (see operation 104) may be re-transmitted periodically a predetermined number of times. In such an aspect, the additional request may be re-transmitted at a higher power level (i.e., to increase the range that the additional request is transmitted from the first mobile wireless device) if an insufficient number of responses are received (after a predetermined amount of time) in response to the previous transmission of the additional request.

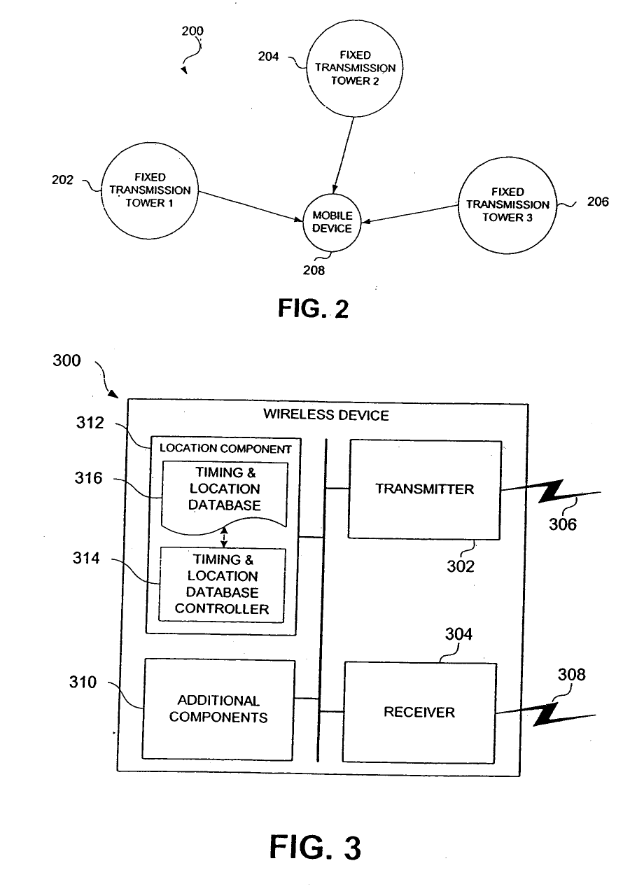

FIG. 2 is a schematic diagram of an ultra-wideband geo-positional model 200 where fixed, known position wireless devices such as transmitters/base stations 202, 204, 206 collaborate with a requesting wireless device 208 to allow the requesting device to determine its location in accordance with an embodiment of the present invention. One feature of ultra-wideband communication systems is that highly accurate geographical positional information may be discernable from signals received from at least three ultra-wideband transmitters (e.g., 202, 204, 206) having known geographical positions. Typically, a device/transceiver (e.g., 208) having an unknown/undetermined location receives ultra-wideband signals from three fixed ultra-wideband transmitters, with the signals sent from each transmitter embedding its time of transmission and the geographical position of each respective transmitter. Using the known position of each fixed transmitter, and measuring the slight timing variations between received signals, the device with an unknown geographical location can triangulate and accurately determine its geographical position. Using such triangulation procedures, an ultra-wideband device can determine its geographical position to within a few centimeters.

As previously mentioned, in an aspect of the preset invention, the wireless devices may comprise impulse radio communication devices such as, for example ultra-wideband radio (also know as digital pulse wireless) communication devices. FIG. 3 is a schematic block diagram of an ultra-wideband wireless device/transceiver 300 in accordance with an embodiment of the present invention. The device 300 has a plurality of components comprising logic (i.e., circuitry), software, or some combination of logic and software. In particular, the device 300 includes a transmitter and a receiver components 302, 304 capable of transmitting and receiving wireless signals 306, 308 (preferably ultra-wideband radio communication signals) respectively. In one embodiment, the signals may carry digital data communication information which may be packetized according to known techniques.

The transmitter and a receiver components 302, 304 may also be coupled to additional components 310 included in the device 300. In an embodiment of the present invention, one of the additional components may comprise a location component 312. In an aspect of the present invention, the location component 312 may include a timing and location database controller 314 which manages and controls a timing and location database 316 in which information such a geo-positional may be stored.

In fixed ultra-wideband transmission towers/base stations, their geographic position is known and can be stored in local memory. In mobile ultra-wideband devices 300 that are within range of three or more fixed ultra-wideband transmission towers, geo-positional information can be actively recorded, updated and stored this in the Dynamic Timing and Location Database 316 of the device 300 on an ongoing basis. Active updating and recording of geo-positional information can occur automatically on a pre-determined time interval, or queried on command.

For example, in an embodiment of the present invention, the location component 312 may receive signals from at least three other wireless devices and then use timing relationships and location information provided in these signals to accurately determine a location for the wireless device 300. With the exact location of the transceiver unit 300 known, and the location of the fixed transmitters known, the location component 312 may be able to precisely determine the distance from the wireless device 300 to the other wireless device. In some embodiments, this distance information, in turn, may be provided to the transmit component 302 so that it can be used to help more accurately adjust the level of power the transmit component uses to transmit the subsequent signals.

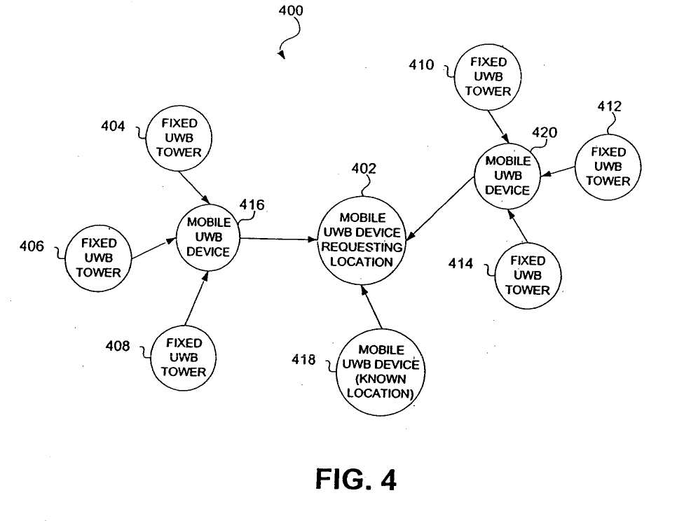

FIG. 4 is a schematic diagram of an ultra-wideband geo-positional model 400 where multiple mobile devices collaborate with a requesting device to allow the requesting device to determine its location in accordance with an embodiment of the present invention. In embodiments of the present invention, tertiary mobile wireless devices (e.g., wireless device 402) that are not within range of three or more towers (e.g., transmission towers 404, 406, 408, 410, 412, 414) can request the geo-positional information stored in the Timing and Location Database of mobile ultra-wideband devices (e.g., devices 416, 418, 420) that are in range and have already stored this information. Such tertiary mobile devices 402 can then use the results of their query of other mobile ultra-wideband devices to triangulate their own position.

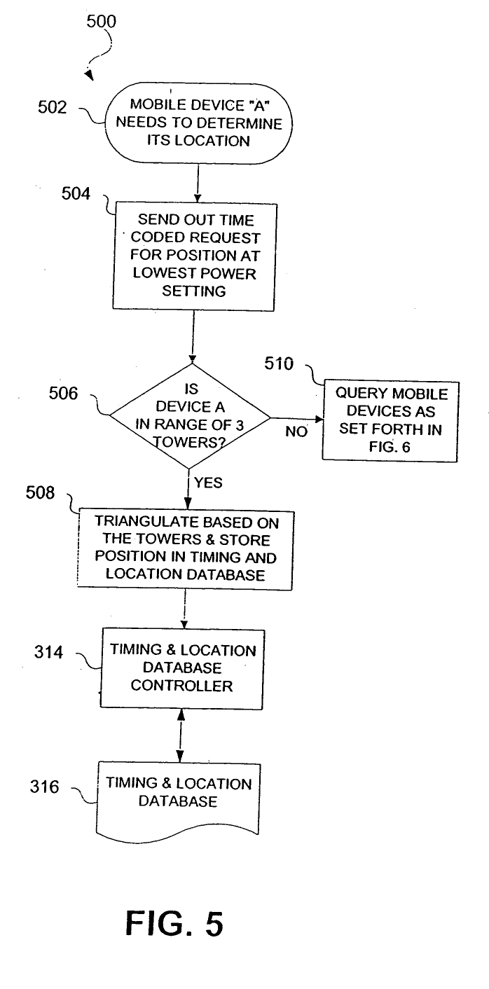

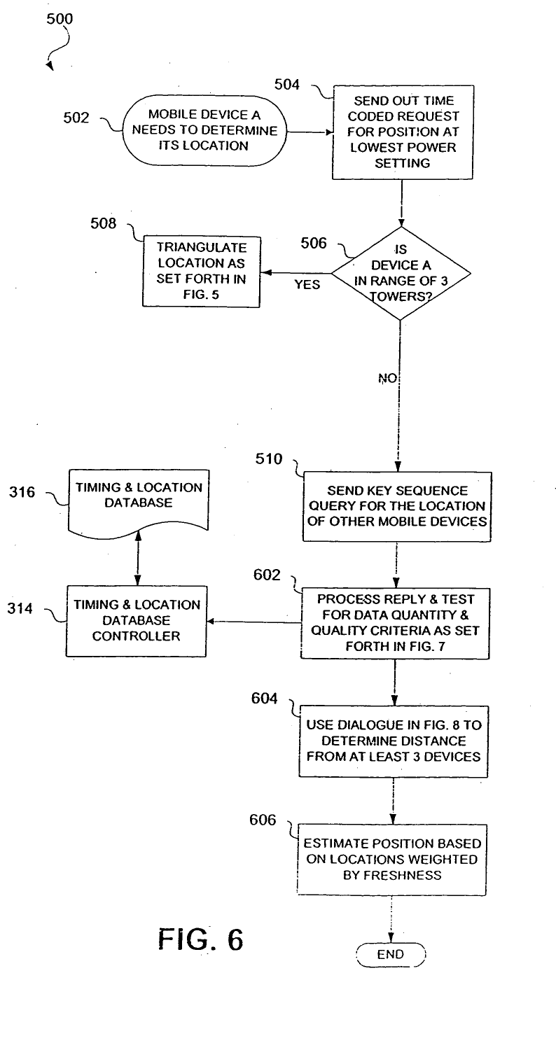

In an embodiment of the present invention, the geographic location of the first mobile wireless device may be determined just from information obtained from the fixed position wireless devices with known geographic locations utilizing a triangulation method if positioning information is received by the first mobile wireless device from a sufficient number (or more) of fixed position wireless devices with known geographic locations (e.g., such as when the sufficient number of fixed position wireless devices with known geographic locations are in the communication range of the first mobile wireless device). FIG. 5 is a flowchart of a process 500 for triangulation with storage of the geo-positional information based on three fixed position devices in accordance with an embodiment of the present invention. When an individual mobile ultra-wideband device A requires a location determination in operation 502, it transmits a coded request (in the form of a key sequence) for the geo-position of three other ultra-wideband devices/towers whose position is known in operation 504. This request may be sent several times (polled) at a pre-selected lowest power setting. By starting key-sequence transmissions at the lowest possible power level, the key-sequence will only reach the smallest transmission range and potentially the smallest number of nearby ultra-wideband devices that might respond to the key sequence request for information. The awaited responses are received in a pre-identified communications channel or set of such channels. If device A is in range of three towers (see decision 506), then it triangulates its own position in operation 508 based on the responses and time stamps, and stores this information in its timing and location database 316 via its timing and location database controller 314.

The timing and location database 316 of the responding ultra-wideband device contains a position value and a time stamp that specifies the time that position value was obtained. In one implementation, the responding device may delay response to the requesting ultra-wideband device until after the responding ultra-wideband device has updated its own most recent geographic position. However, in a preferred implementation, the decision to use the position reported by the responding device lies with the requesting device. The requesting device makes this determination based on the time stamp and other information provided by the responding device. The moving/mobile nature of the responding ultra-wideband devices and the need to synchronize the requesting device with the responding devices also complicate the determination of location.

If the querying wireless device (i.e., device A) is determined not to be in range of at least three towers in decision 506, then other wireless devices (e.g., other mobile wireless devices) proximate to the querying device may be queried per operation 510. In one embodiment of the present invention, the location of the first mobile wireless device may be estimated with a triangulation method using only the information obtained from the at least a portion of the responding other mobile wireless device if no positioning information is received by the first mobile wireless device from fixed position wireless devices with known geographic locations (i.e., zero (0) fixed position wireless devices). FIG. 6 is a flowchart of a process for determining and storing a geographic location of a mobile wireless device in a wireless communication system per operation 510 in accordance with an embodiment of the present invention. FIG. 6 shows the overall position discovery algorithm based on a requesting mobile device's ability to contact a suitably large number of location-self-aware devices. As was the case in FIG. 5, the device acquiring location is referred to as device A in FIG. 6.

Device “A” first tries to communicate with three or more base stations in order to triangulate its position (per operations 504, 506, 508). Since the base stations have exact location information and highly accurate timekeeping hardware, this may be the most accurate method of position determination. If fewer than three base stations are available (per decision 506), the device (i.e., device A) starts the request for information from other mobile devices by transmitting a key-sequence at the lowest possible power level per operation 510. In operation 602, replies are processed and tested for data quality and quantity criteria (preferably utilizing the timing and location database and controller 316, 314). In one aspect, each responding device may be identified by its unique ID number. Additionally, the range of IDs for base stations may not overlap those of mobile devices. If there are no replies, or if the replies contain data of low accuracy, device A keeps on polling for respondents. If polling the preprogrammed number of times fails to generate any replies, the requesting device may then ramp up the transmit power. In operation 604, a ranging dialogue is performed to determine the requesting wireless device's distance from other replying wireless devices in order to permit the estimation of the requesting wireless device's position in operation 606 based on the determined distances weighted by their freshness using a triangulation method. In an embodiment of the present invention, a time stamp for the estimated position/location may be generated, and then the estimated position/location and the associated time stamp may be stored in a memory (such as in a timing and location database) of the first mobile wireless device utilizing a timing and location database controller of the first mobile wireless device.

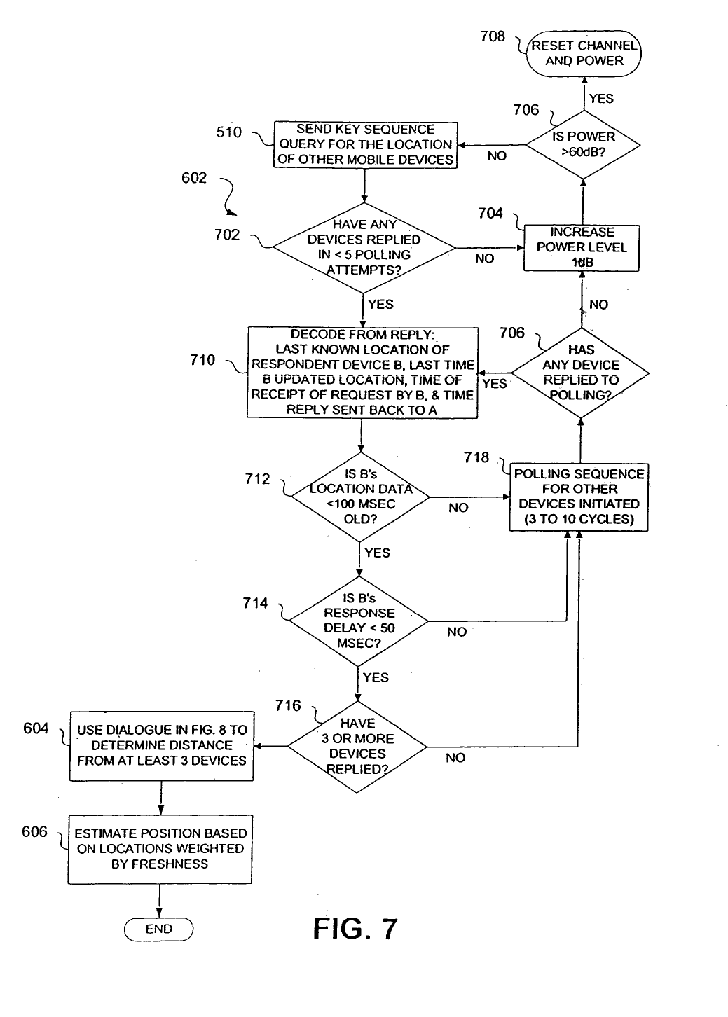

FIG. 7 is a flowchart processing replies from other wireless devices and testing for data quantity and quality criteria per operation 604 of FIG. 6 in accordance with an embodiment of the present invention. As discussed previously, if device A is not in range of three towers, it then transmits the key sequence in order to locate other mobile devices per operation 510. As the other mobile devices respond, a dialogue is established between the requestor and each responding device to determine distance and clock disparity. If the requesting device does not receive a response in a reasonable time (in a preferred embodiment, up to 5 msec—depending on the environment), the requesting device will retry several times using the same power level and multiple access channels (see decision 702). If no devices have replied to this repeated polling, then a power ramping algorithm is initiated, and the keyed sequence is transmitted again at a higher power level (see operation 704). Once the maximum allowable power is reached without response (see decision 706), the requestor will switch to another multiple access channel in operation 708.

With continuing reference to FIG. 7, important data quality and quantity criteria are also used device A to determine the value of the data it receives. It should be noted that only other wireless devices that have acquired their position will respond to the query of operation 510. If there are no responses to the polling, device A boosts its output power level until another mobile device responds (per operation 708).

With reference to the YES path of decision 702, if a device proximate to the requesting device (i.e., device A) receives the request transmitted by device A and has acquired information concerning its own geographic position/location, then such a device may transmit a response to the device A (the responding mobile device will be referred to hereafter as device B). Device “B” may encode several pieces of information into its reply including, for example: (1) the freshness of its position information (i.e., how recently the position information was obtained and/or updated); (2) a time of receipt that the query from device A was received by device B; and (3) a time of reply that a reply to the to the query was transmitted from device B to device A. Upon receiving the reply, device A can decode the reply in order to obtain the encoded information in operation 710.

With continuing reference to FIG. 7, the information obtained from each reply to the request by device A can be tested to determine how much emphasis should put on the information provided in the response of the particular device B. In decision 712, the information from a device B may be tested to determine whether the position information of device B is stale (i.e., too old and/or has not been updated recently). Clearly, if device B has not updated its information in a long time (for example, in a preferred embodiment, longer than 100 msec), the location of device B may have incurred significant error.

Next, in decision 714, the information decoded from the response may be tested to determine if the delay taken by device B in responding to the request is above a predetermined threshold (e.g., in a preferred embodiment, greater than 50 msec). For example, if device B took an inordinate amount of time to process the query (hereafter referred to as processing time), device B may be overloaded and prone to thread conflicts that will induce timing errors. In such a case, device B's reply will not be as accurate as device A may require. After performing the tests in decisions 712 and 714, a subsequent determination is made by device A as to whether the replies of three or more devices (i.e., three or more device B's) have been received by device A in decision 716. If three or more device B's have replied and at least three of the replies pass the tests set forth in decisions 712 and 714 (see the YES paths of decisions 712 and 714), then the dialog to determine device A's distance from three other devices may be executed per the YES path of decision 716 and operation 604. Conversely, if the information of a reply fails either of the tests (see the NO paths of decisions 712 and 714), or the replies of less than three device B's have past the tests, then per operation 718, a polling sequence for other devices is initiated.

There are several circumstances where distance calculation based on nearby devices may be prone to certain types of error. For some responding devices the processing delay experienced by device B will be a multiple of the signal's propagation delay. In such cases, the response by “B” may be degraded by simultaneous occurring multi-path reflections from the original query. In such cluttered environments, where reflection of the query may return to “A” at the same time as the reply from “B”, it becomes necessary to re-query “B” and notify it of the multi-path duration. Once “B” receives this information it can resubmit its reply so it will not be degraded by multi-path. On the other hand, if “A” calculates device B to be very far away, then the possibility increases that the reception is not direct line, and significant error is highly probable.

Once three or more devices have replied, then an estimated position can be obtained per 606. If more than three devices reply to the query, a determination can be made based on the information provided by the responding devices as to the quality of the estimated distances. Any devices over the required three can be graded and then added to the estimate weighted by a quality factor calculated from the time of last update, chance of multi-path interference, replier overload, and distance degradation.

In yet another aspect of the present invention, the obtained information relating to the distance between the first mobile wireless device and the portion of the responding other mobile wireless devices may include a calculated distance between the first mobile wireless device and the portion of the responding other mobile wireless devices, a transmission time, and a scaling factor.

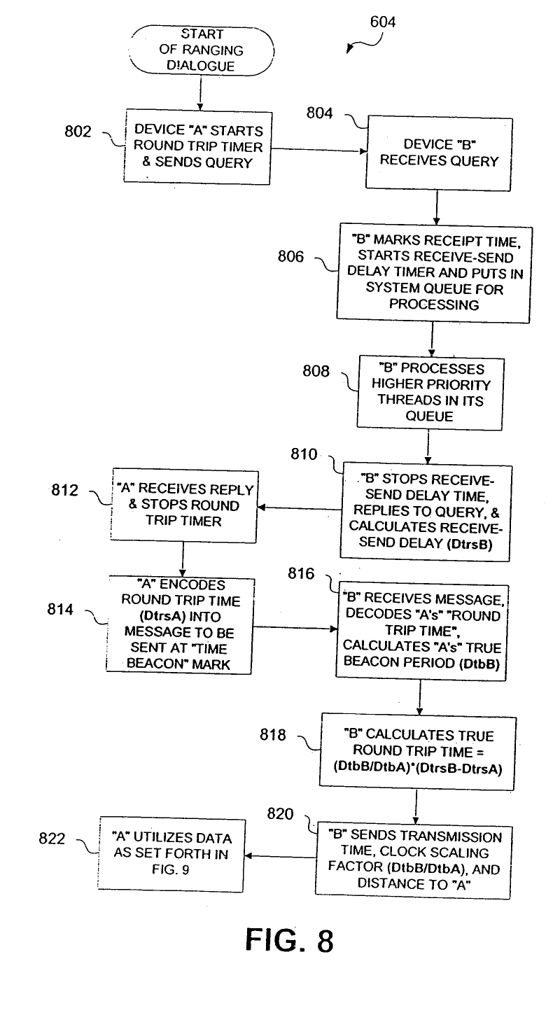

FIG. 8 is a flowchart of a process for performing a ranging dialogue to determine a requesting wireless device's distance from other replying wireless devices per operation 604 in accordance with an embodiment of the present invention. FIG. 8 shows the dialogue that must go on in order for device A to determine its position with respect to device B. In operation 802, device A starts a timer that is used to count the clock ticks between the time device A sends a query and the time “A” receives a response from “B”. This time is denoted as “Δ_{tsrA}” (or “DtrsA”). This time includes the round trip signal time plus the time it takes for device B to respond to the query (a substantial delay given that device B is likely to be busy at the time the query is received). Since the oscillator on device A may have undergone some drift since the last time device A's position was determined, Δ_{tsrA} is only an estimate of the true round trip time.

Once device B receives the query in operation 804, device B marks the receipt time, starts the receive-send delay timer and continues processing those threads that were being processed at the time it received the query until it has enough time to respond to the query (see operations 806 and 808). When device B is ready to respond to the query, “B” stops the timer and calculates the receive-send delay Δ_{trsB} (or “DtrsB”) and A's time scaling factor in operation 810.

In operation 812, device A receives the reply, stops the round trip timer, and calculates the round-trip time “Δ_{trsA}” (or “DtrsA”). Device A then encodes this value into a message to be sent to device B at its next “time beacon” mark in operation 814. A time beacon mark occurs at the end of a specified time period that starts with the sending of the original query. The time beacon period may either be a preprogrammed constant for both devices A and B, or its value may be transmitted by devices A to B in the initial query.

In operation 816, device B receives the message and decodes the round trip time. Device B then calculates the time difference between the original query and the reply at the “time beacon” mark to calculate the true beacon period (“DtbB”) (see operation 816). In operation 818, device B then uses the ratio of the beacon period preprogrammed in device A to the true beacon period as calculated by device B as a multiplier (i.e., the “scaling factor”) to correct the round trip time as calculated by device A. Once the actual time is obtained, the receive-send delay incurred by device B can be subtracted out to obtain the actual round trip propagation time. Device B then sends the scaling factor, transmission time and calculated distance to device A in operation 820. In operation 822, upon receipt, device A may use this information transmitted from device B for time correction.

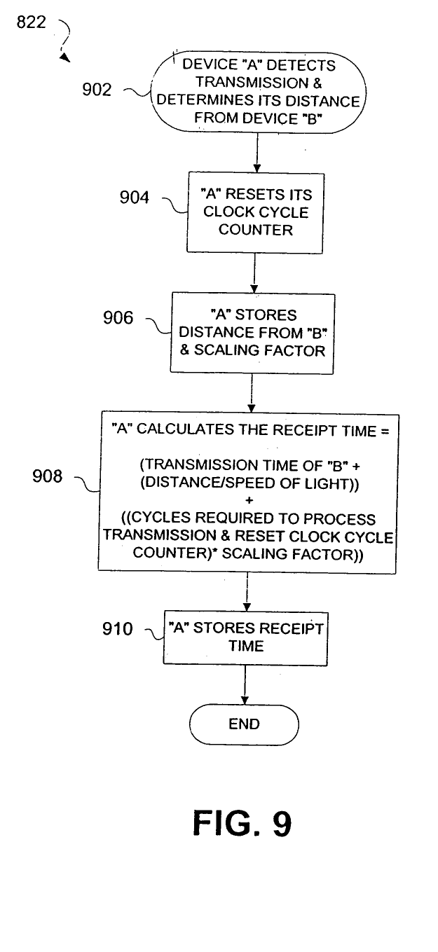

FIG. 9 is a flowchart of a process for time correction in a requesting wireless device per operation 822 of FIG. 8 in accordance with an embodiment of the present invention. As set forth in FIG. 9, shows that as soon as device A receives the transmission from device B (see operation 902), device A resets its clock cycle counter in operation 904. Device A then decodes the transmission and extracts the parameters for storage in its timing and location database (see operation 906).

Besides updating its location, device A can use these parameters to 15 resynchronize its clock. In one aspect of the present invention, at least a portion of the obtained information (such as the transmission time and scaling factor) may be utilized to update an internal clock of the first mobile wireless device. In closer detail, this may be accomplished per operation 908 by calculating a Receipt Time using the following equation:

Receipt Time=(transmission time of device B+distance/speed of light)+(time required to process transmission and reset clock cycle counter),

where:

(time required to process transmission and reset clock cycle counter)=(cycles required to process transmission and reset the clock cycle counter)*(scaling factor)

Device “A” then stores the calculated Receipt Time in operation 910. Subsequent time calculations by device A are then based on the following equation:

True Current Time=(value of clock cycle counter)*(scaling factor)+(Receipt Time)+(number of cycles to calculate and process (transmit, store, etc.) True Current Time)

In multi-user environments, it is feasible that dozens of ultra-wideband devices may be within transmit/receive range of the location-requesting ultra-wideband device. Simultaneous responses from all of these devices can “collide” and prove to be unintelligible to the requesting device. In an aspect of the present invention, a set of collision-avoidance schemes may be provided which are designed to reduce collisions when an individual ultra-wideband device requests geo-positional information from multiple nearby ultra-wideband devices in a multi-user environment.

Implementations of collision avoidance schemes may employ the following:

1. Pre-identification of several multiple access channels to be used for receiving responses to the geo-positional key sequence and assign one of these channels to each mobile device. This reduces but does not eliminate the possibility that multiple responses to the key sequence request will be received in the same channel;

2. Superposition of multiple coincident responses using pulse position modulation (a preferred modulation scheme) may lead to disallowed pulse adjacency at the receiver. If this happens, the requesting device may ignore the reply. The responding devices expect a rapid acknowledgement from the requesting device (up to 5 msec depending on the environment). The lack of a prompt acknowledgement from the requesting device may induce the responding devices to retransmit their responses using other pre-identified multiple access channels assigned for positional response information. To decrease the probability that second responses from multiple devices will interfere with each other, these multiple access channels can be chosen at random and/or the transmission can be postponed by random delays. These random factors can be obtained by using a random number generator where the seed is based on an individual device's unique identification code. The individual device's ID codes can also be used directly to institute a lag that is unique to each device; and

3. The geo-positional key sequence may be generated at the lowest possible power level, and the power level is increased only after between 3 and 10 polling sequences have been transmitted with no response. The power ramping and polling sequence proceeds until the first response is obtained or until the assigned maximum power level has been reached. The power level is increased gradually such that the potential number of new respondents is kept low while insuring the minimum number or respondents, three, is achieved as rapidly as possible. After maximum power is reached with no response, the ultra-wideband device will then switch channels and start the polling and power ramping sequence again at the lowest power setting.

Embodiments may also include a repetitive polling sequence that helps to assure that a potential respondent will be able to receive the request. Since the requesting device expect a rapid acknowledgement from the responding devices, if the requesting devices do not receive such an acknowledgement in a reasonable time (up to 5 msec depending on the environment), then the requestor will retry up to 10 polling sequences before ramping up the power or moving to another multiple access channel.

Additionally, embodiments may provide a means to simultaneously synchronize the users clock and calculate the distance based on one round trip from the responding device.

Thus embodiments of the present invention may allow for the employment of geo-positional information in a broader range of environments. It uses and “piggybacks” the existence of multi-user environments to extend the capacity of the ultra-wideband system. It extends the capacity for acquisition of geo-positional information throughout a multi-user ultra-wideband environment. Aspects of the present invention may also help to reduce the probability of collisions in multi-user environments. The ability to extend geo-positional functionality under a wider variety of circumstances may become a future requirement of FCC regulations under extension of their “e911” policy.

Referring to FIG. 13, a schematic diagram of an ultra-wideband geo-positional model 1100 is illustrated. Multiple ultra-wideband (UWB) devices collaborate with a requesting UWB device to enable the requesting device to determine its location and elevation in accordance with an embodiment of the present invention. One feature of this embodiment of the present invention is that an elevation of the UWB requesting unit 1105 can be determined. This can be helpful in many situations, for example, where the location of an individual in a high-rise building must be determined. In addition, one feature of this embodiment of the present invention is that it accounts for situations where the elevation between an UWB requesting unit 1105 is not the same as the elevation of the other UWB units 1110.

Referring again to FIG. 13, the location of an UWB requesting unit 1105 can be determined by measuring the time delay in a signal transmitted by the UWB requesting unit 1105 to each of the UWB units 1110. The UWB units 1110 may have either a fixed location or they may be mobile UWB units. One method of finding the location of the UWB requesting unit 1105 employs radio triangulation and calculates distance from the amount of time required for a signal transmitted by the UWB requesting unit 1105 to reach each of the UWB units 1110. Specifically, the distance between the UWB requesting unit 1105 and each of the UWB units 1110 can be determined based on the amount of time it takes for a signal to travel between the devices. Each distance generates a radius, with each UWB unit 1110 at the center of a circle defined by each radius. The intersection of the three circles defines the location of the UWB requesting unit 1105.

An alternative technique to determine a location of an UWB requesting unit 1105 may employ two directional antennas that may be incorporated into the UWB units 1110. For example, a phased array antenna or other type of antenna capable of determining direction may be employed and only two antennas would be required to determine the location of an UWB requesting unit 1105. This is because a point (the UWB requesting unit 1105) can be found at the intersection of two arcs formed by the distance and direction information supplied by the UWB units 1110.

As discussed above, the location of the UWB requesting unit 1105 can also be determined by obtaining information from other devices not initially queried. With reference to FIG. 4, if an initial request transmitted by the UWB requesting unit 1105 does not result in a sufficient amount of data to generate a location, a second request for information from other UWB units may be transmitted. These tertiary devices, fixed or mobile, may then submit information to the UWB units 1110 which will then relay the information to the UWB requesting unit 1105, or the tertiary devices may submit the information directly to the UWB requesting unit 1105.

Again referring to FIG. 13, a method of determining an elevation of an UWB requesting unit 1105 will now be described. As shown in the Figure, a calculated distance from each UWB unit 1110 may result in three different elevation error points 1115. This may occur when an UWB requesting unit 1105 transmits a request to the UWB units 1110 to determine a location of the UWB requesting unit 1105, and the UWB requesting unit 1105 is at a different elevation than the UWB units 1110. The elevation error points 1115 represent distances that are beyond the actual location of the UWB requesting unit 1105. The additional distance reflects the elevation difference between the UWB requesting unit 1105 and the UWB units 1110.

However, one embodiment of the present invention includes computer logic or computer readable program code to determine a position and elevation of an UWB requesting unit 1105 when the elevation of the UWB requesting unit 1105 is different than the elevation of the UWB units 1110. One method involves the use of the Pythagorean theorem. This method employs the total distance from a UWB unit 1100 to the elevation error point 1115 as the hypotenuse of a triangle. Another side of the triangle is determined by taking the difference between the distance from the UWB requesting unit 1105 and the elevation error point 1115 and subtracting that distance from the distance between the UWB unit 1100 and the elevation error point 1115. With two sides of an imaginary triangle determined, the third side of the triangle can be found using the Pythagorean theorem. In the present invention, the third side of the triangle represents the elevation of the UWB requesting unit 1105.

In a preferred embodiment of the present invention, the Pythagorean calculation described above is performed three times, using the distance data from each of the three UWB units 1100 to their respective elevation error points 1115. Thus, the elevation of the UWB requesting unit 1105 is found, and determining the elevation of the UWB requesting unit 1105 eliminates the elevation error and the substantially precise location of the UWB requesting unit 1105 is resolved.

The above-described calculations require an approximate location of the UWB requesting unit 1105. One embodiment of the present invention determines a centroid of the elevation error area 1120. The centroid of the elevation error area 1120 is then used as an approximate location of the UWB requesting unit 1105. The elevation error area 1120 comprises an area defined by three imaginary lines joining the three elevation error points 1115, and the centroid is the point within the area at which the center of mass would be if the area had a mass.

Alternative methods of determining an approximate location of the UWB requesting unit 1105 may employ a variety of other optimization techniques, such as adaptive neural networks, or other methods available to those skilled in the art.

As also discussed above, if an insufficient amount of information is received by the UWB requesting unit 1105 from the UWB units 1110, a second request may be transmitted by the UWB requesting unit 11 05 to other more-distant UWB units that can then supply the information necessary to fix the elevation and location of the UWB requesting unit 1105.

In addition, an alternative embodiment to the present invention may include computer logic or computer programs that access a terrain elevation database, such as topographical maps, terrain maps or other elevation information to determine an elevation of a UWB requesting unit 1105. In addition, a historical map or historical information based on previous elevation determinations in the area of the UWB requesting unit 1105 may also be accessed to determine an elevation of the UWB requesting unit 1105. As discussed above, one feature of the present invention is that a UWB requesting unit 1105 can determine its elevation based on information obtained from either local UWB units 1110 or more-distant units, that directly communicate with the UWB requesting unit 1105, or that are accessed via the UWB units 1110. These more-distant units create an ad hoc network to provide a sufficient amount of information to determine the elevation of the UWB requesting unit 1105.

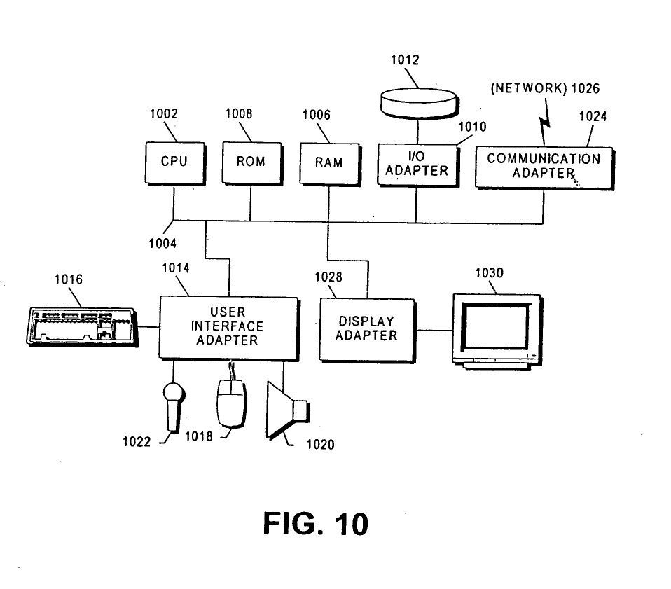

FIG. 10 illustrates a representative hardware environment 1000 by which embodiments of the present invention may be carried out is depicted in FIG. 10. In the present description, the various sub-components of each of the components may also be considered components of the system. For example, particular software modules executed on any component of the system may also be considered components of the system. The hardware configuration 1000 illustrated in FIG. 10 includes a central processing unit 1002, such as a microprocessor, and a number of other units interconnected via a system bus 1004.

The hardware configuration 1000 shown in FIG. 10 includes a Random Access Memory (RAM) 1006, Read Only Memory (ROM) 1008, an 110 adapter 1010 for connecting peripheral devices such as disk storage units 1012 to the bus 1004, a user interface adapter 1014 for connecting a keyboard 1016, a mouse 1018, a speaker 1020, a microphone 1022, and/or other user interface devices such as a touch screen (not shown) to the bus 1004, communication adapter 1024 for connecting the hardware configuration to a communication network 1026 (e.g., a data processing network) and a display adapter 1028 for connecting the bus 1004 to a display device 1030.

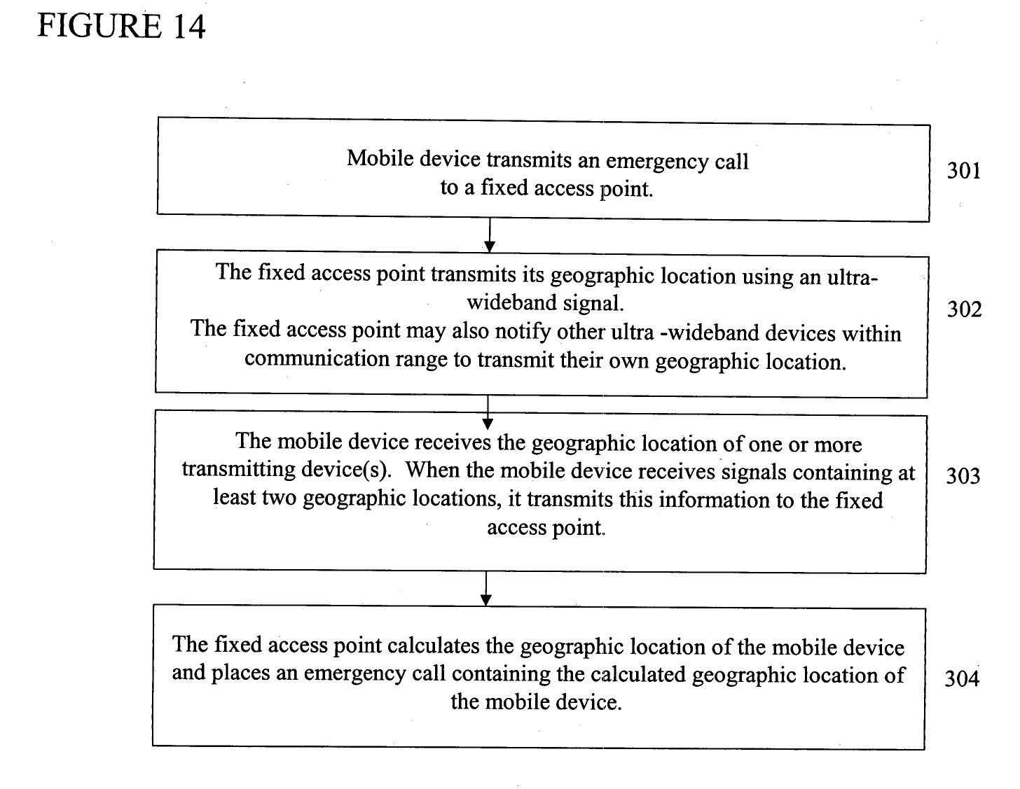

Referring to FIGS. 14-20, a system, method and apparatus for determining and/or reporting a location of a mobile communication device is illustrated. The Federal Communications Commission (FCC) has issued a series of orders that seek to improve the reliability of wireless 911 services, and to provide emergency services personnel with location information that should enable them to locate and provide assistance to mobile 911 callers.

The present invention employs ultra-wideband (UWB) technology to provide accurate location information of a mobile communication device to 911 services. In addition, one aspect of the present invention provides a method to report the location of a mobile device either by employing ultra-wideband technology alone, or by employing ultra-wideband technology in conjunction with conventional narrowband communications technology. The location of the mobile communication device may be determined as described above, or it may be determined by employing the methods described in co-pending U.S. patent application Ser. No. 09/805,735, filed Mar. 13, 2001, titled: MAINTAINING A GLOBAL TIME REFERENCE AMONG A GROUP OF NETWORKED DEVICES, which is incorporated herein in its entirety by this reference. One aspect of the above-incorporated patent application is that UWB enabled devices, that is, mobile communication devices that employ ultra-wideband technology as described above, may be synchronized to a single master time reference. Once the communicating UWB devices are synchronized to the master time reference, distance measurements may be made by any of the communicating devices. To determine distance, a receiving UWB device only needs to know the time of transmission and the time of arrival of the UWB pulse, or signal. Since the communicating UWB devices are synchronized to the same master time reference, the reference for the time of transmission is consistent between the UWB devices. The time of arrival of the UWB signal is determined by the receiving device, and contained within the UWB signal is the signal's time of transmission. The distance between UWB devices is obtained by determining the difference between the transmission time and the arrival time, and multiplying it by the UWB signal speed. Because the transmission time and the arrival time are both referenced to the same master time reference, the distance calculation will be accurate.

One embodiment of the present invention may be a mobile communication device that is equipped with a UWB receiver and a narrowband transceiver. In this embodiment the emergency call is sent by the narrowband transceiver to the nearest fixed access point. The fixed access point may be a cellular communications station, or other suitable communications access system. The fixed access point initiates a geo-position beacon signal over a UWB communications channel. The fixed access point may additionally signal other fixed access points to initiate a similar geo-position beacon signal. In this embodiment, the mobile communication device receives geo-position beacon signals from a plurality of fixed access points. The mobile device then transmits the information in the received geo-position beacon signals and their time of receipt to the nearest fixed access point over the narrowband communications channel by using the narrowband transceiver.

The mobile communication device may then calculate its geo-position, or geographic location from the received signals, or alternatively the receiving fixed access point may calculate the mobile device's location. In the first alternative, the mobile device would be able to determine distances from a plurality of fixed access points and report either its position relative to those access points, or its geo-position in a standard coordinate system, such as latitude and longitude. In the second alternative, the mobile device may report the time of receipt and an identifier associated with the destination of each beacon message. The receiving fixed access point may then calculate the geo-position of the mobile communication device.

For the sake of clarity and not limitation, narrowband communication technology as used herein refers to non-ultra-wideband (non-UWB) communications technologies that may include, but are not limited to, carrier-based wireless technologies as described above, CDMA, GSM or other spread spectrum technologies, Bluetooth, WiFi, or other non-UWB wireless communications technologies. Additionally, the term “fixed access point” as used herein is intended to encompass any fixed location wireless enabled device such as cellular communication systems and other fixed network components or systems.

In another embodiment of the present invention, the mobile device may be equipped with a narrowband transceiver and a UWB transceiver. The mobile device may request the transmission of a geo-positional signal from all UWB enabled devices within its geographic area. In this embodiment, other UWB devices that have knowledge of their geo-position may assist the requesting mobile device in determining its geographic location.

In a still further embodiment of the present invention, the fixed access points may periodically transmit geographic location signals. In this embodiment, each UWB enabled device may determine its geographic location at a regular interval. Alternatively, each UWB enabled mobile device may receive and store a number of the geographic location signals and their time of arrival. In this alternative embodiment, the UWB enabled mobile device may transmit the stored geographic location information when it places an emergency call.

One feature of the present invention is that the UWB enabled devices may transmit UWB pulses, or signals at a fixed power level or the power of transmission of the UWB pulse, or signals may be incrementally increased up to a predetermined maximum value. This method would increase the transmission range of the UWB pulses, or signals.

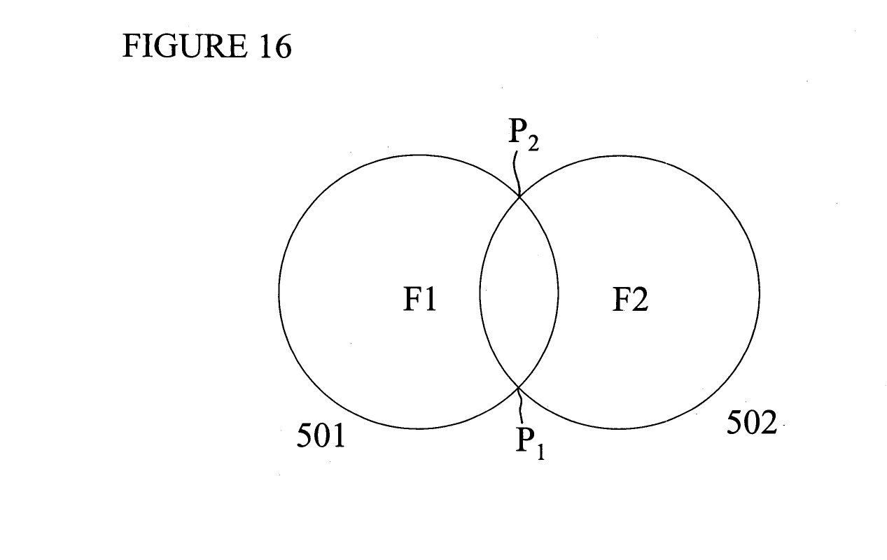

Referring now to FIG. 16, one embodiment of the present invention may determine the location of a mobile device by employing terrain information in conjunction with geographic location information. For example, a mobile device (not shown) may only be in communication with two other communication devices F1 and F2. Devices F1 and F2 may be other mobile devices, or fixed communication devices. The mobile device may receive a signal from device F1, and determine its distance to device F1. This distance information places the mobile device somewhere on circle 501. The mobile device may then receive a signal from device F2, and determine its distance to device F2. This information places the mobile device somewhere on circle 502. However, this will only localize the mobile device to two possible locations, P₁ and P₂, where circles 501 and 502 intersect. In this case, terrain information may be employed to determine which of the two possible locations is the most probable. The terrain information may include data on roads, highways, mountains, lakes, or other terrain information that may aid in determining where the probability of the mobile device location may be higher or lower.

Referring to FIG. 14, one method of determining a location of a mobile device, and reporting the location of the mobile device, is illustrated. In step 301, the mobile device, which may be a phone, a personal digital assistant, a portable computer, a laptop computer, or any other mobile device, initiates an emergency call. The emergency call may be received by a fixed access point, or it may be received by another mobile device that forwards the emergency call to a fixed access point. In a preferred embodiment, the mobile device sends an emergency call to the closest fixed access point employing a narrowband signal.

In step 302, the fixed access point transmits its geographic location signal employing an UWB communications link. Additionally, the fixed access point may notify other UWB enabled devices within communication range to broadcast their own geographic location to the mobile device that placed the emergency call. This notification step may be accomplished through wire or wireless communications media using conventional narrowband or UWB communications technologies. In an alternative embodiment, where fixed access points routinely transmit their geographic location, step 302 may be limited to instructing the other mobile UWB enabled devices to transmit their geographic location.

In step 303, the mobile device receives at least two geographic location signals from transmitting UWB enabled devices. In one embodiment of the present invention, the mobile device calculates its own geographic location and transmits this information to the nearest fixed access point across a narrowband communications channel. Alternatively, the mobile device may transmit its geographic location to another mobile UWB device that forwards it to a fixed access point. In another embodiment, the mobile device may store the received geographic location information from the responding UWB devices and transmit it to the fixed access point.

In step 304, the fixed access point receives the calculated geographic location information from the mobile device that sent the emergency call, and forwards the emergency call and the calculated geographic location information to the 911 services. In the embodiment where the mobile device does not calculate its position, the fixed access point receives the stored geographic location information that the mobile device received, and calculates the location of the mobile device that sent the emergency call. It then forwards the calculated geographic location of the mobile device, and an emergency call to 911 services.

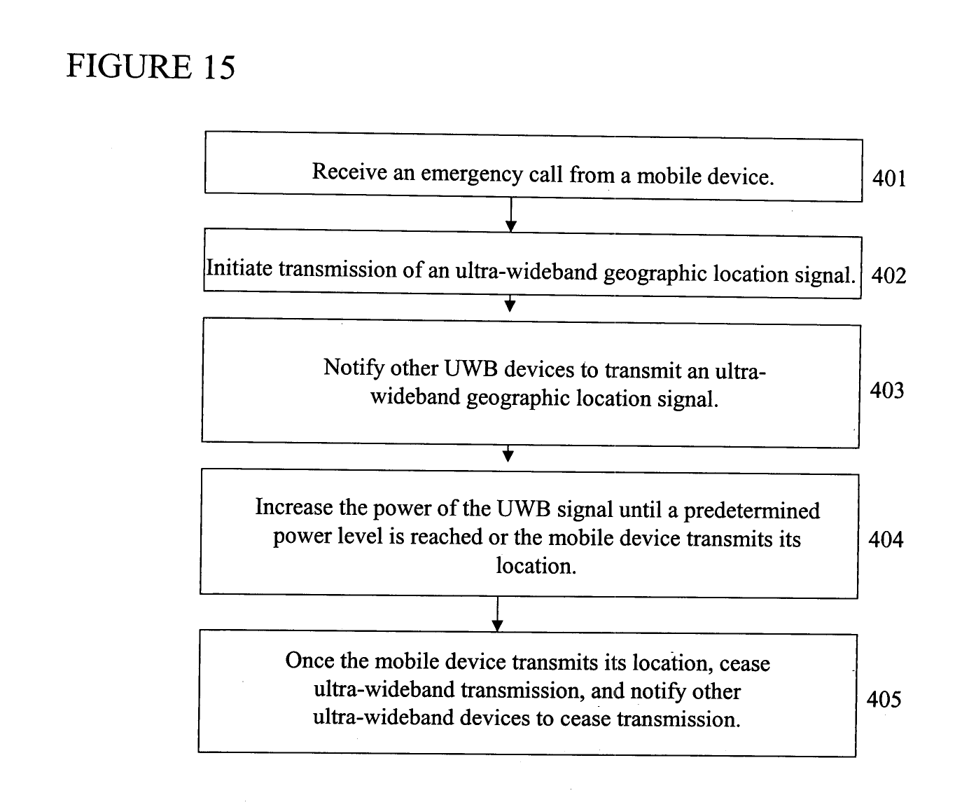

Referring to FIG. 15, one method of determining, and reporting, the location of a mobile device is illustrated. In step 401, a fixed access point receives an emergency call from a mobile device. In step 402, the fixed access point then transmits a geographic location signal employing an UWB communications channel to the mobile device that sent the emergency call. Alternatively, in an embodiment where fixed access points routinely transmit their geographic location, step 402 may not be necessary.

In step 403, the fixed access point notifies other UWB enabled devices to transmit their own geographic location to the mobile device that sent the emergency call. The notification process in this step may consist of sending a signal across a wire or wireless medium employing narrowband or UWB communications technology. In an embodiment where fixed access points routinely transmit their geographic location, this step may comprise notifying mobile UWB devices via a wireless communications channel.

In step 404, the UWB enabled devices may transmit their geographic location at a predetermined power level or they may increase their power of transmission to a predetermined maximum over the course of a number of discrete transmissions. The UWB enabled devices may continue to transmit at increased power levels until the mobile device that sent the emergency call receives geographic location information from at least two responding devices. The responding devices may comprise a mobile UWB enabled device, and a fixed access point, or two fixed access points, or any other combination that provides two geographic locations to the mobile device that sent the emergency call. Preferably, the mobile device that sent the emergency call will receive geographic location information from at least three responding devices, but as discussed above, the mobile device that sent the emergency call can determine its position using only two geographic locations.

In step 405 the fixed access point receives geographic location information from the mobile device and notifies other UWB devices to cease transmission of their signals. In one embodiment, the fixed access point would then calculate the geographic location of the mobile device. In another embodiment, the mobile device would calculate its own geographic location and send it to the fixed access point.

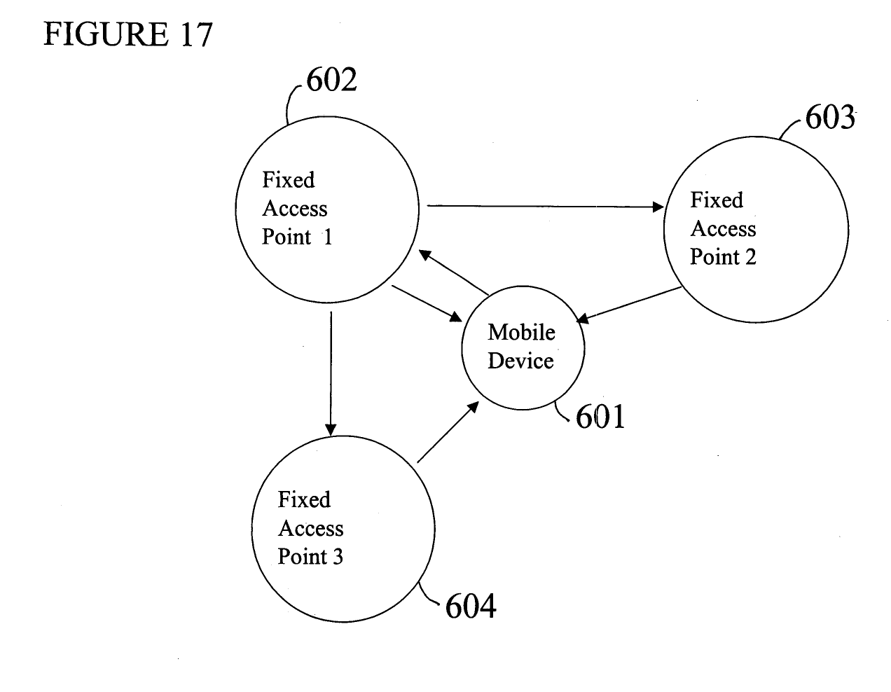

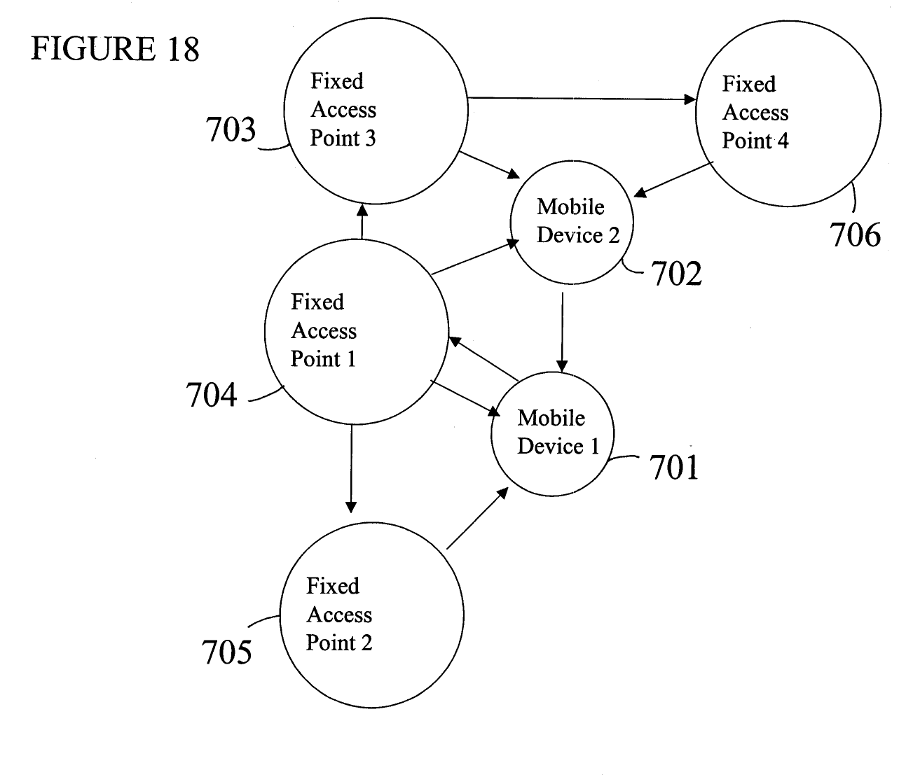

Referring to FIGS. 17 and 18, two methods of determining and reporting the geographic location of a mobile device are illustrated. In FIG. 17, the mobile device 601 is in communication with three fixed access points 602, 603, and 604. Given three distinct geographic location signals, mobile device 601 may calculate its geographic location and report it to the fixed access point 602. Alternatively, mobile device 601 may report its location to fixed access point 602. In this embodiment, fixed access point 602 calculates the geographic location of mobile device 601.

In FIG. 18, mobile device 701 may not be in range of three fixed access points 703, 704, 705, and 706. In this situation mobile device 702 may assist in the determination of the geographic location of device 701. Device 702 can establish its geographic location from the signals received from fixed access points 703, 704, and 706. Mobile device 702 may then transmit a signal to device 701. This signal may include the geographic location of mobile device 702 or may include information about transmission time from and the geographic location of fixed access point 706. Mobile device 701 may then calculate its geographic location from the signals received from fixed access points 704 and 705 and the information provided by mobile device 702.

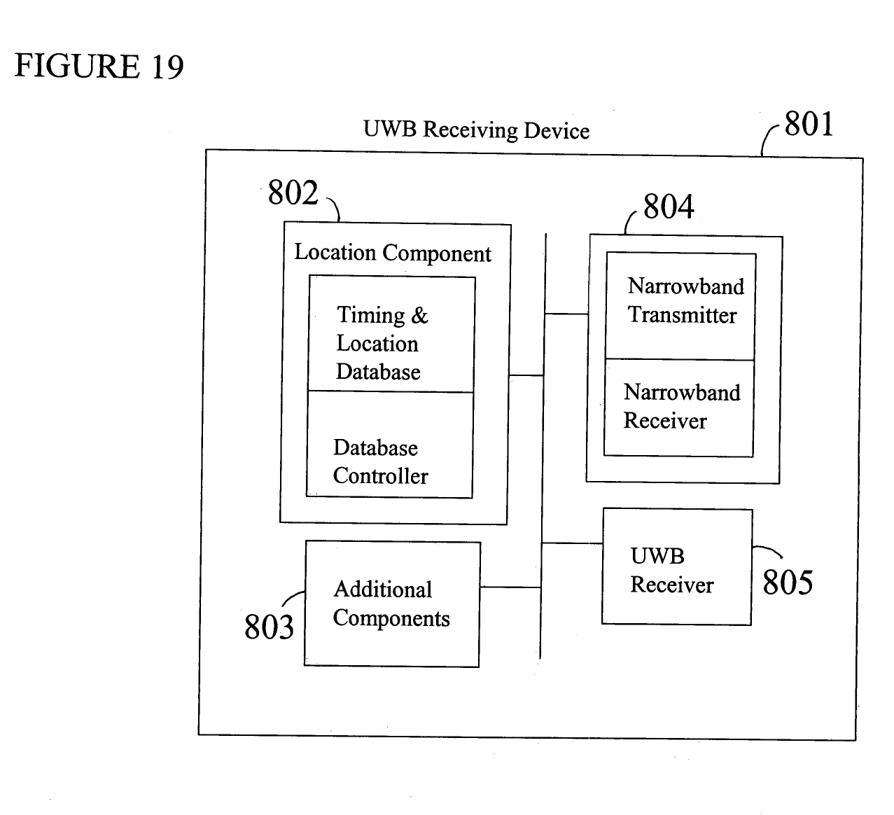

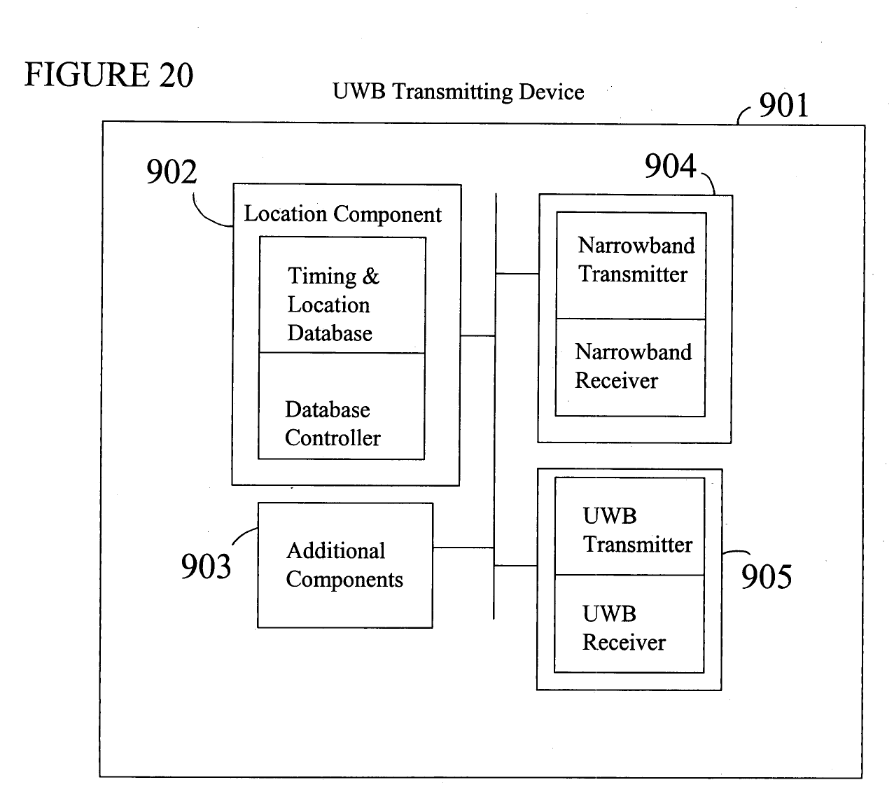

Referring to FIGS. 19 and 20, schematic block diagrams of the components comprising two UWB enabled devices are illustrated. In FIG. 19, an UWB receiving device 801 comprises a narrowband transceiver, or transmitter and receiver 804, a UWB receiver 805, and additional components 803 necessary for communications. Since UWB receiving device 801 has a UWB receiver but not a UWB transmitter, all outgoing communications would be transmitted across a narrowband communications channel by narrowband transceiver 804. UWB receiving device 801 may optionally contain a location component 802 that stores location information. UWB receiving device 801 could calculate geographic location information from incoming signals and transmit this information via the narrowband transceiver 804. Alternatively, UWB receiving device 801 may re-transmit the received signals to the fixed access point via narrowband transceiver 804. In this embodiment, the fixed access point would calculate the geographic location of the UWB receiving device 801.

Referring to FIG. 20, the UWB transmitting device 901 differs from UWB receiving device 801 in that UWB transmitting device 901 has both a narrowband receiver and transmitter, or transceiver 904 and a UWB transmitter and receiver, or UWB transceiver 905. UWB transmitting device 901 also has any other additional components 903 necessary for communications. The UWB transmitting device 901 may transmit any or all geographic information to the fixed access point employing either a narrowband communications channel or an UWB communications channel. UWB transmitting device 901 may assist other UWB enabled devices in determining their geographic location by using the UWB transmitter and receiver, or UWB transceiver 905 to send a geographic location beacon message when required.

Thus, it is seen that a system, method and article of manufacture are provided for determining and/or reporting a location of a wireless device. One skilled in the art will appreciate that the present invention can be practiced by other than the above-described embodiments, which are presented in this description for purposes of illustration and not of limitation. The description and examples set forth in this specification and associated drawings only set forth preferred embodiment(s) of the present invention. The specification and drawings are not intended to limit the exclusionary scope of this patent document. Many designs other than the above-described embodiments will fall within the literal and/or legal scope of the following claims, and the present invention is limited only by the claims that follow. It is noted that various equivalents for the particular embodiments discussed in this description may practice the invention as well.

What is claimed is:

1. A method of reporting the geographic location of a wireless communications device, the method comprising steps of:
emitting an emergency signal from the wireless communication device;
receiving the emergency signal at at least two access points, and transmitting at least two ultra-wideband signals in response, the ultra-wideband signals containing information about the geographic locations of the access points;
determining a geographic location of the wireless communication device using the geographic locations of the access points; and
transmitting the geographic location of the wireless communication device.

2. The method of claim 1, wherein the emergency signal or the ultra-wideband signal comprise a plurality of ultra-wideband pulses, the ultra-wideband pulses having a duration ranging between about 0.1 nanosecond and about 1.0 millisecond.

3. The method of claim 1, wherein the access points are communication devices selected from a group consisting of: a fixed location ultra-wideband communication system, a fixed location narrowband communication system, a CDMA cellular telephone communication system, a GSM cellular telephone communication system, a mobile device employing ultra-wideband technology, a portable telephone, a personal digital assistant, a portable computer, and a laptop computer.

4. The method of claim 1, further including the step of:
increasing a transmission power of the ultra-wideband signals until the wireless communication device receives the ultra-wideband signals.

5. The method of claim 1, further including the step of:
determining the location of the wireless communication device by using terrain data and the geographic locations of the access points.

6. The method of claim 5, wherein the terrain data is comprised of data selected from a group consisting of: topographical data, highway location data, surface road location data, expressway location data, toll-road location data, lake location data, mountain location data, coastline location data, and man-made structure location data.

7. The method of claim 1, wherein the step of determining the geographic location of the wireless communication device using the geographic locations of the access points is performed by the wireless communication device or by at least one of the access points.

8. The method of claim 1, wherein the step of transmitting the geographic location of the wireless communication device is performed by the wireless communication device or by at least one of the access points.

9. The method of claim 1, wherein the emergency signal comprises a 911 signal.

10. The method of claim 1, further including the step of transmitting a 911 signal with the transmission of the geographic location of the wireless communication device.

11. The method of claim 1, further including the step of transmitting the geographic locations of the access points with a 911 signal if the geographic location of the wireless communication device cannot be determined.

12. A system for reporting the geographic location of a wireless communications device, comprising:
logic for emitting an emergency signal from the wireless communication device;
logic for receiving the emergency signal at at least two access points, and transmitting at least two ultra-wideband signals in response, the ultra-wideband signals containing information about the geographic locations of the access points;
logic for determining a geographic location of the wireless communication device using the geographic locations of the access points; and
logic for transmitting the geographic location of the wireless communication device.

13. A method of reporting the geographic location of a wireless communications device, the method comprising steps of:
emitting an emergency signal from the wireless communication device;
receiving the emergency signal at an access point;
transmitting an ultra-wideband signal from the access point to at least two ultra-wideband devices, requesting the ultra-wideband devices transmit their geographic locations;
receiving the geographic locations of the ultra-wideband devices at the wireless communication device;
determining a geographic location of the wireless communication device using the geographic locations of the ultra-wideband devices; and
transmitting the geographic location of the wireless communication device.

14. The method of claim 13, wherein the emergency signal comprises a 911 signal.

15. The method of claim 13 further including the step of transmitting a 911 signal with the transmission of the geographic location of the wireless communication device.

16. The method of claim 13, wherein the at least two ultra-wideband devices and the wireless communication device are selected from a group consisting of: a mobile device employing ultra-wideband technology, a portable telephone, a personal digital assistant, a portable computer, and a laptop computer.

17. The method of claim 13, further including the step of:
increasing a transmission power of the ultra-wideband signals from the ultra-wideband devices transmitting their geographic locations until the wireless communication device receives the ultra-wideband signals.

18. The method of claim 13, further including the step of:
determining the location of the wireless communication device by using terrain data and the geographic locations of the ultra-wideband devices.

19. The method of claim 18, wherein the terrain data is comprised of data selected from a group consisting of: topographical data, highway location data, surface road location data, expressway location data, toll-road location data, lake location data, mountain location data, coastline location data, and man-made structure location data.

20. The method of claim 18, wherein the step of determining the geographic location of the wireless communication device using the geographic locations of the ultra-wideband devices is performed by the wireless communication device or by at least one of the ultra-wideband devices.

21. The method of claim 13, wherein the step of transmitting the geographic location of the wireless communication device is performed by the wireless communication device or by at least one of the ultra-wideband devices.

22. The method of claim 13, further including the step of:
stopping the transmission of the geographic locations of the ultra-wideband devices once the geographic location of the wireless communication device is determined.

23. A method of reporting the geographic location of a wireless communications device, the method comprising steps of:
means for emitting an emergency signal from the wireless communication device;
means for receiving the emergency signal at an access point;
means for transmitting an ultra-wideband signal from the access point to at least two ultra-wideband devices, requesting the ultra-wideband devices transmit their geographic locations;
means for receiving the geographic locations of the ultra-wideband devices at the wireless communication device;
means for determining a geographic location of the wireless communication device using the geographic locations of the ultra-wideband devices; and
means for transmitting the geographic location of the wireless communication device.

24. A method of reporting the geographic location of a wireless communications device, the method comprising steps of:
periodically transmitting a geographic location signal from at least two access points;
emitting an emergency signal from the wireless communication device;
determining a geographic location of the wireless communication device using the geographic locations of the access points; and
transmitting the geographic location of the wireless communication device.

25. The method of claim 24, wherein the emergency signal or the geographic location signal comprise a plurality of ultra-wideband pulses, the ultra-wideband pulses having a duration ranging between about 0.1 nanosecond and about 1.0 millisecond.

26. The method of claim 24, wherein the access points are communication devices selected from a group consisting of: a fixed location ultra-wideband communication system, a fixed location narrowband communication system, a CDMA cellular telephone communication system, a GSM cellular telephone communication system, a mobile device employing ultra-wideband technology, a portable telephone, a personal digital assistant, a portable computer, and a laptop computer.

27. The method of claim 24, further including the step of:
determining the location of the wireless communication device by using terrain data and the geographic locations of the access points.

28. The method of claim 27, wherein the terrain data is comprised of data selected from a group consisting of: topographical data, highway location data, surface road location data, expressway location data, toll-road location data, lake location data, mountain location data, coastline location data, and man-made structure location data.

29. The method of claim 24, wherein the step of determining the geographic location of the wireless communication device using the geographic locations of the access points is performed by the wireless communication device or by at least one of the access points.

30. The method of claim 24, wherein the emergency signal comprises a 911 signal.

31. The method of claim 24, further including the step of transmitting a 911 signal with the transmission of the geographic location of the wireless communication device.

32. A method of reporting the geographic location of a wireless communications device, the method comprising steps of:
means for periodically transmitting a geographic location signal from at least two access points;
means for emitting an emergency signal from the wireless communication device;
means for determining a geographic location of the wireless communication device using the geographic locations of the access points; and
means for transmitting the geographic location of the wireless communication device.

33. A method of reporting the geographic location of a wireless communications device, the method comprising steps of:
emitting an emergency signal from the wireless communication device;
receiving the emergency signal at a fixed access point;
transmitting the emergency signal to at least one other fixed access point,
transmitting the geographic location of each fixed access point;
determining a geographic location of the wireless communication device using the geographic locations of the fixed access points; and
transmitting the geographic location of the wireless communication device.

34. The method of claim 33, wherein the step of transmitting the emergency signal to at least one other fixed access point comprises transmitting the emergency signal using a signal transmission method selected from a group consisting of: a CDMA signal transmission method, a GSM signal transmission method, a Bluetooth signal transmission method, a WiFi signal transmission method, and a non-ultra-wideband wireless signal transmission method.
